(19) United States
(12) Patent Application Publication
(10) Pub. No.: US 2015/0286599 A1
(43) Pub. Date: Oct. 8, 2015

(54) CHASSIS IDENTIFICATION METHOD USING MODULATION

(71) Applicant: THOMSON LICENSING, Issy de Moulineaux (FR)

(72) Inventor: Steven Thomas Hershberger, Fortville, IN (US)

(21) Appl. No.: 14/667,875

(22) Filed: Mar. 25, 2015

Related U.S. Application Data
(60) Provisional application No. 61/974,527, filed on Apr. 3, 2014.

(51) Int. Cl. G06F 13/40; G06F 1/18

(52) U.S. Cl. CPC G06F 13/4022; G06F 1/185; G06F 13/4068

(57) ABSTRACT

The present disclosure discloses a chassis on which a plurality of daughter cards (circuits) can be implemented. The chassis includes a backplane; a plurality of slots attached to the backplane, the plurality of slots being configured to interface with a corresponding number of daughter cards; a switch attached to the backplane, the switch being configured to provide control inputs to each of the plurality of slots, wherein a subset of the plurality of slots are directly connected to the switch; and a processor attached to the backplane and connected to the switch, the processor being connected to a portion of the plurality of slots which are not directly connected to the switch, the processor being configured to receive a signal from the switch, modulate the signal, and transmit the modulated signal to a target slot of the portion of the plurality of slots to uniquely identify a daughter card in the target slot.

### FIELD OF INVENTION

The following disclosure relates to identifying daughter cards (circuits) in a chassis, and more particularly to a method of providing multiple processors in a system with a unique configuration input from a dual in-line package (“DIP”) switch.

### BACKGROUND

Television head end systems, particularly those for satellite television systems, include one or more chassis, each holding a plurality of daughter cards (or circuits) that are connected to a satellite dish. In order for such a system to operate, the daughter cards which fit into any particular chassis need to identify themselves as to which chassis and which slot in the chassis each one is connected. In such circumstances, a set of control signals are sent to each daughter card to identify which chassis and which slot each particular daughter card is connected.

In some such systems, a dual in-line package (DIP) switch is employed to identify the chassis itself, and the control lines from the DIP switch are fed to the daughter cards. Typically, if a DIP switch is used to provide a unique configuration input to multiple processors, only two logic states can be generated—Logic High or Logic Low, depending on the position of the DIP switch. If one wished to increase the number of daughter cards that could potentially be installed on the chassis, one would have to increase the number of configuration states the DIP switch can create. Conventionally, increasing the number of configuration states for a processor requires an additional processor input to provide the configuration to the processor. However, processors that have limited input/output capacity render this method ineffective. Also, this method creates problems for systems that need to be expanded yet remain backwards compatible with an existing system.

### SUMMARY

In view of the foregoing background, it is desirable to create additional slots in a chassis of a head end system without having to include additional processor inputs. The following disclosure identifies at least one embodiment that meets these goals.

A chassis on which a plurality of daughter cards (circuits) can be installed is presented for one embodiment. The chassis includes a backplane; a plurality of slots attached to the backplane, the plurality of slots being configured to interface with a corresponding number of daughter cards; a switch attached to the backplane, the switch being configured to provide control inputs to each of the plurality of slots, wherein a subset of the plurality of slots are directly connected to the switch; and a processor attached to the backplane and connected to the switch, the processor being connected to a portion of the plurality of slots which are not directly connected to the switch, the processor being configured to receive a signal from the switch, modulate the signal, and transmit the modulated signal to a target slot of the portion of the plurality of slots to uniquely identify a daughter card in the target slot.

### BRIEF DESCRIPTION OF THE DRAWINGS

For a more complete understanding of the present principles, reference is made to the following detailed description of an embodiment considered in conjunction with the accompanying drawings, in which:

FIG. 1 is a diagram of a chassis in accordance with an embodiment of the present principles; and

FIG. 2 is a flow chart illustrating a process of assigning unique internet protocol addresses in accordance with an embodiment of the present principles.

### DETAILED DESCRIPTION OF THE INVENTION

The following is presented to provide an illustration of the general principles of the present embodiments and is not meant to limit, in any way, the inventive concepts contained herein. Moreover, the particular features described in this section can be used in combination with the other described features in each of the multitude of possible permutations and combinations contained herein. All terms defined herein should be afforded their broadest possible interpretation, including any implied meanings as dictated by a reading of the specification as well as any words that a person having skill in the art and/or a dictionary, treatise, or similar authority would assign particular meaning. Further, it should be noted that, as recited in the specification and in the claims appended herein, the singular forms ‘a,’ “an,” and “the” include the plural referents unless otherwise stated. Additionally, the terms “comprises” and “comprising” when used herein specify that certain features are present in that embodiment, however, this phrase should not be interpreted to preclude the presence or additional of additional steps, operations, features, components, and/or groups thereof.

The present principles generally relate to a chassis for a system having multiple daughter cards or electronic circuits that allows for the addition of multiple daughter cards without requiring a corresponding number of processor inputs being added. The chassis accomplishes this through the use of a DIP switch and a modulator which together create a modulated signal that a daughter card can use to identify its unique position in the system. By using such a chassis, a system, such as, for example, a television head end system, can expand the number of daughter cards it can employ while limiting the number of control inputs necessary and remaining backwards compatible with older interfacing systems.

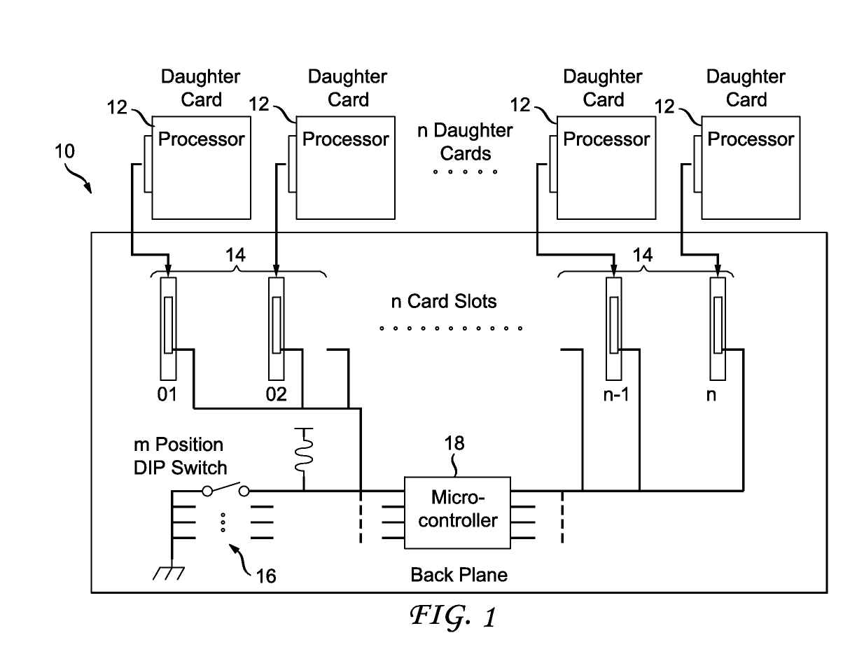

FIG. 1 illustrates a backplane chassis 10 that allows for the addition/subtraction of multiple daughter cards 12 in accordance with an embodiment of the present principles. One skilled in the art will recognize that a daughter card represents an electronic circuit that can be added/removed from a chassis for a number of purposes (to gain additional functionality and/or to remove or upgrade functions, etc.). The circuits interface with the chassis via slots in a backplane. The backplane chassis 10 includes a plurality of interface slots 14 corresponding to the number of daughter cards 12 in which a single daughter card can interconnect. The backplane chassis 10 also includes a DIP switch 16 which a user can set to provide a unique identifier for each of the daughter cards 12 on the backplane chassis 10. A select number of interface slots 14 (i.e., slots 1 to k) are connected directly to the DIP switch 16 and receive a direct current signal therefrom. These interface slots 14 are able to determine their unique IP addresses from the signals they receive directly from the DIP switch 16.

The backplane chassis 10 also includes a microcontroller 18 connected to the DIP switch 16 and the remaining number of interface slots 14 (i.e., slots k+1 to n). The microcontroller 18 provides a modulated output that depends upon the logic state of the DIP switch 16. Any of the daughter cards 12 that receive a signal from the microcontroller 18 would be able to determine if the DIP switch signal were in Logic High (e.g., 100 kHz) and Logic Low (e.g., 10 kHz). Such information would then allow each of the daughter cards 12 in the slots 14 connected to the microcontroller 18 (i.e., slots k+1 through n) to identify its own unique internet protocol (IP) address.

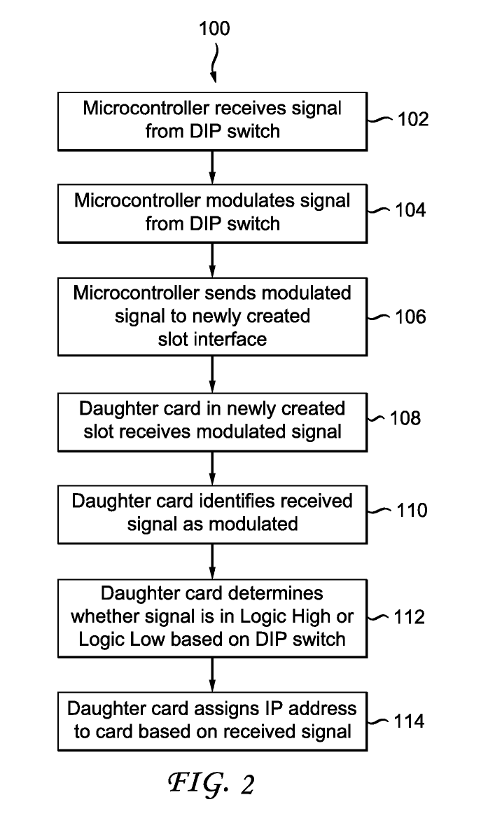

FIG. 2 illustrates a method 100 of assigning a unique IP address to a daughter card in the nth slot of the chassis illustrated in FIG. 1 in accordance with an embodiment of the present principles. The method begins with the DIP switch 16 sending a signal to the microprocessor 18 that corresponds to the position in which the DIP switch 16 has been set (step 102). The microprocessor 18 then modulates the signal from the DIP switch 16 to a frequency corresponding to the position of the DIP switch 16 (e.g., 100 kHz for Logic High; 10 kHz for Logic Low) (step 104). The microcontroller 18 then sends the modulated signal to one of the interface slots 14 connected to the microcontroller 18 (e.g., slot n) (step 106).

A daughter card in slot n of the interface slots 14 receives the modulated signal of microprocessor 18 (step 108) and begins processing it. The daughter card first identifies that the signal is modulated (step 110) and part of the chassis 10. The daughter card then identifies whether the modulated signal is in a logic high or logic low state (step 112). Based on these two parameters, the daughter card is able to identify to which chassis and slot it is connected, and then assigns itself a unique IP address based on these values (step 114).

The modulated signal received by the daughter card allows it to differentiate itself from the daughter card directly connected to the DIP switch that is associated with the same DIP switch configuration. In one embodiment, the daughter cards 12 connected to the microcontroller 18 include QAM modulators that are able to decipher whether an incoming signal from the microcontroller 18 is modulated and at what frequency the signal is modulated.

The various embodiments disclosed herein can be implemented as hardware, firmware, software, or any combination thereof. Moreover, the software is preferably implemented as an application program tangibly embodied on a program storage unit or computer readable medium. The application program can be uploaded to, and executed by, a machine comprising any suitable architecture. Preferably, the machine is implemented on a computer platform having hardware such as one or more central processing units (“CPUs”), a memory, and input/output interfaces. The computer platform can also include an operating system and microinstruction code. The various processes and functions described herein can be either part of the microinstruction code or part of the application program, or any combination thereof, which can be executed by a CPU, whether or not such computer or processor is explicitly shown.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art can make many variations and modifications without departing from the spirit and scope of the invention. All such variations and modifications are intended to be included within the scope of the invention as defined in the appended claims.

1. A chassis comprising:
a backplane;
a plurality of slots attached to the backplane, the plurality of slots being configured to interface with a corresponding number of circuits;
a switch attached to the backplane, the switch being configured to provide control inputs to each of the plurality of slots; and
a processor attached to the backplane and connected to the switch, the processor being connected to a portion of the plurality of slots, the processor being configured to receive a signal from the switch, modulate the signal, and transmit the modulated signal to a target slot of the portion of the plurality of slots to uniquely identify a circuit in the target slot.

2. The chassis of claim 1, wherein the switch is a dual in-line package (DIP) switch.

3. The chassis of claim 1, wherein uniquely identifying a circuit includes assigning a unique internet protocol address to the circuit.

4. The chassis of claim 1, wherein the modulated signal exists in a logic state that corresponds to a position of the switch.

5. The chassis of claim 1, wherein a second subset of the plurality of slots are directly connected to the switch.

6. A method of uniquely identifying a circuit in an expansion slot of a chassis, the chassis including a processor that connects a switch and the expansion slot, the method comprising:
receiving, at the processor, a signal from the switch, the signal corresponding to a position set by the switch;
modulating, at the processor, the signal to a frequency corresponding to the position set by the switch;
sending the modulated signal to the circuit in the expansion slot; and
assigning a unique identifier to the circuit in the expansion slot based upon the frequency of the modulated signal, wherein the frequency of the modulated signal corresponds to a chassis and slot number that represents a position of the circuit in the expansion slot.

7. The method according to claim 6, wherein the switch is dual in-line package (DIP) switch.

8. The method according to claim 6, wherein assigning the unique identifier includes assigning a unique internet protocol address to the circuit.

9. The method according to claim 6, further comprising sending, from the switch, a direct signal to a second circuit in a directly connected slot, the direct signal corresponding to a second position set by the switch, and assigning a unique identifier to the second circuit based upon the direct signal.
